(19) United States
(12) Patent Application Publication
(10) Pub. No.: US 2015/0212619 A1
(43) Pub. Date: Jul. 30, 2015

(54) TOUCH SENSOR

(71) Applicant: Samsung Electro-Mechanics Co., Ltd., Gyeonggi-Do (KR)

(72) Inventors: Young Seuck YOO, Gyeonggi-Do (KR); Kang Heon HUR, Gyeonggi-Do (KR); Jae Hun KIM, Gyeonggi-Do (KR); Dek Gin YANG, Gyeonggi-Do (KR); Jin Uk LEE, Gyeonggi-Do (KR); Seung Joo SHIN, Gyeonggi-Do (KR); Hyun Chul JUNG, Gyeonggi-Do (KR)

(73) Assignee: SAMSUNG ELECTRO-MECHANICS CO., LTD., Gyeonggi-Do (KR)

(21) Appl. No.: 14/291,641

(22) Filed: May 30, 2014

(30) Foreign Application Priority Data
Jan. 24, 2014 (KR) 10-2014-0009162

(51) Int. Cl. G06F 3/044

(52) U.S. Cl. CPC G06F 3/044

(57) ABSTRACT

Embodiments of the invention provide a touch sensor including a base substrate, and electrode patterns formed of metal wires which are formed by stacking at least two electrode layers on the base substrate and have groove portions formed on both sides thereof. The groove portions are filled with anticorrosive members.

### CROSS REFERENCE TO RELATED APPLICATION

This application claims the benefit of and priority under 35 U.S.C. §119 to Korean Patent Application No. KR 10-2014-0009162, entitled “TOUCH SENSOR,” filed on Jan. 24, 2014, which is hereby incorporated by reference in its entirety into this application.

### BACKGROUND

1. Field of the Invention

The present invention relates to a touch sensor.

2. Description of the Related Art

With the development of computers using a digital technology, computer-aided devices have also been developed, and personal computers, portable transmitters and other personal exclusive information processors execute processing of texts and graphics using a variety of input devices such as a keyboard and a mouse.

With the rapid advancement of an information-oriented society, the use of computers has gradually been expanded; however, it is difficult to efficiently operate products using only a keyboard and a mouse which currently serve as input devices. Therefore, the necessity for a device, which has a simple configuration and less malfunction and is configured for anyone to easily input information, has been increased.

In addition, technologies for input devices have progressed toward techniques related to high reliability, durability, innovation, designing and processing, as non-limiting examples, in addition to satisfying general functions. To this end, a touch sensor has been developed as input devices capable of inputting information such as texts and graphics.

This touch sensor is equipment which is mounted on a display surface of a display such as an electronic organizer, a flat panel display device including a liquid crystal display (LCD) device, a plasma display panel (PDP), an electroluminescence (El), as non-limiting examples, or a cathode ray tube (CRT) to thereby be used to allow a user to select desired information while viewing the display.

In addition, a type of the touch sensor may be classified into a resistive type, a capacitive type, an electro-magnetic type, a surface acoustic wave (SAW) type, and an infrared type. These various types of touch sensors have been adapted for electronic products in consideration of a signal amplification problem, a resolution difference, a difficulty of designing and processing technology, optical characteristics, electrical characteristics, mechanical characteristics, anti-environment characteristics, input characteristics, durability, and economic efficiency. Currently, the resistive touch sensor and the capacitive touch sensor have been used in a wide range of fields.

Meanwhile, in the touch sensor, as described, for example, in Japanese reference JP2011-175967A1, research to form an electrode pattern using metal has been actively conducted. In the case of forming the electrode pattern using metal, electrical conductivity is excellent and a supply and demand is smooth, but there are problems of a difficulty of implementing a fine pattern due to a difference in an etching level of lower portions of electrode patterns during a patterning process for forming the electrode patterns, the reduction in reliability due to the corrosion resistance of the exposed electrode pattern, for example.

### SUMMARY

Accordingly, embodiments of the invention have been made in an effort to provide a touch sensor capable of improving corrosion resistance of an exposed portion of an electrode pattern and adhesive reliability between the electrode pattern and a transparent substrate by using a stacked structure in which the electrode pattern of the touch sensor is made of at least two different materials.

According to various embodiments of the invention, there is provided a touch sensor including a base substrate, and electrode patterns formed of metal wires which are formed by stacking at least two electrode layers on the base substrate and have groove portions formed on both sides thereof. The groove portions are filled with anticorrosive members.

According to an embodiment, the metal wire is formed by sequentially stacking a first electrode layer, a second electrode layer, and a third electrode layer from one surface of the base substrate, a line width of the first and third electrode layers is formed to be larger than a line width of the second electrode layer, the groove portions are formed in a region corresponding to the line width of the first and third electrode layers from both sides of the second electrode layer, and the groove portions are filled with the anticorrosive members.

According to an embodiment, the anticorrosive member is an organic solderability preservative.

According to an embodiment, the metal wire is formed by sequentially stacking a second electrode layer and a third electrode layer from one surface of the base substrate, a line width of the third electrode layer is formed to be larger than a line width of the second electrode layer, the groove portions are formed in a region corresponding to a line width of the third electrode layers from both sides of the second electrode layer, and the groove portions are filled with the anticorrosive members.

According to an embodiment, the organic solder preservative is benzimidazole or trichlorobenzene.

According to an embodiment, the first and third electrode layers are made of an alloy of copper (Cu) and nickel (Ni).

According to an embodiment, the second electrode layer is made of copper (Cu), aluminum (Al), or a combination thereof.

According to an embodiment, the third electrode layer is made of an alloy of copper (Cu) and nickel (Ni).

According to an embodiment, the second electrode layer is made of copper (Cu), aluminum (Al), or a combination thereof.

According to an embodiment, the electrode pattern is formed in a mesh pattern formed of the metal wire.

According to an embodiment, a thickness in a stacking direction of the first and third electrode layers is formed to be thinner than that of the second electrode layer.

According to an embodiment, a thickness in a stacking direction of the third electrode layer is formed to be thinner than that of the second electrode layer.

According to an embodiment, the electrode pattern includes first electrode patterns formed on one surface of the base substrate in parallel with each other and second electrode patterns formed on the other surface of the base substrate, so as to intersect with a direction in which the first electrode patterns are formed.

According to an embodiment, the base substrate includes first and second base substrates and the electrode pattern includes first electrode patterns formed on one surface of a first base substrate in one direction in parallel with each other and second electrode patterns formed on one surface of the second base substrate in a direction intersecting the first electrode patterns in parallel with each other and formed to face the first base substrate.

According to an embodiment, the touch sensor further includes a damp-proofing member sealing the metal wire.

According to another embodiment of the invention, there is provided a method for manufacturing a touch sensor, including sequentially stacking at least two electrode layers on a base substrate, forming electrode patterns formed of metal wires having groove portions formed on both sides by patterning the electrode layers, and forming an anticorrosive layer by filling the groove portions formed on both sides of the metal wires with anticorrosive members.

According to an embodiment, in the stacking of the electrode layer, a first electrode layer, a second electrode layer, and a third electrode layer are sequentially stacked on the base substrate, in the forming of the electrode pattern, a line width of the first and third electrode layers forming the metal wires is formed to be larger than that of the second electrode layer and form the groove portions from both sides of the second electrode layers to a region corresponding to the line width of the first and third electrode layers, and in the forming of the anticorrosive member, the groove portions are filled with the anticorrosive members to form the anticorrosive layer.

According to an embodiment, the anticorrosive member is an organic solderability preservative.

According to an embodiment, the organic solder preservative is benzimidazole or trichlorobenzene.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a cross-sectional view of a touch sensor according to an embodiment of the invention.

FIGS. 2A and 2B are diagrams illustrating an electrode pattern of the touch sensor according to an embodiment of the invention.

FIG. 3 is a plan view of the electrode pattern according to an embodiment of the invention.

FIGS. 4A and 4B are cross-sectional views of a metal wire forming an electrode pattern according to a first embodiment of the invention taken along the line I-I′ of FIG. 3.

FIGS. 5A and 5B are cross-sectionals view of a metal wire forming an electrode pattern according to a second embodiment of the invention taken along the line I-I′ of FIG. 3.

FIGS. 6A to 6D are diagrams illustrating a method for manufacturing a touch sensor according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

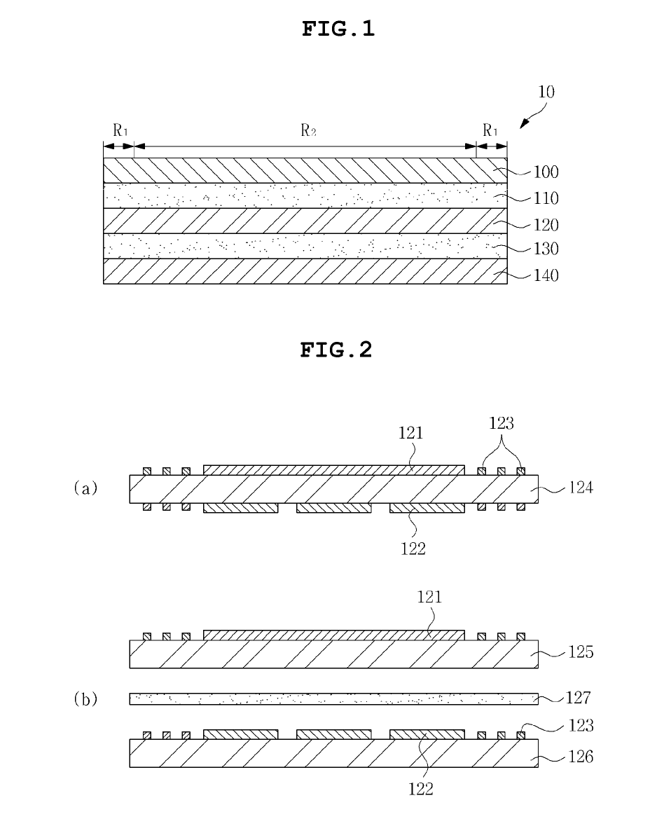

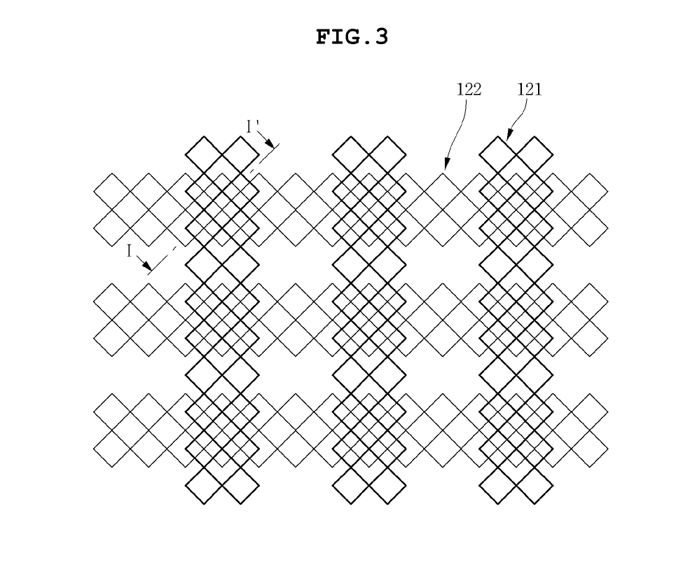

FIG. 1 is a cross-sectional view of a touch sensor according to an embodiment of the invention, FIGS. 2A and 2B are diagrams illustrating an electrode pattern of the touch sensor according to an embodiment of the invention, and FIG. 3 is a plan view of the electrode pattern according to an embodiment of the invention.

As illustrated in FIGS. 1 to 3, a touch sensor 10 according to an embodiment of the invention includes a window substrate 100, electrode patterns 121 and 122 formed on base substrates 124, 125, and 127, a sensor module 120 bonded to face the window substrate 100, and a display module 140, which represents an output value for an input of a user by the touch sensor 10 and is bonded to one surface of the touch sensor 10.

According to an embodiment, the window substrate 100 includes a central region R1 and an edge region R2, which is formed to enclose the central region R1 and is disposed at an outermost portion of the touch sensor 10 to be able to receive a user's touch and is made, for example, of tempered glass to be able to serve as a passivation layer, and a bezel part (not illustrated) and the electrode patterns 121 and 122 are formed on a rear surface of the window substrate 100, and therefore a surface treating layer (not illustrated) is formed by performing high frequency treatment or primer treatment, as non-limiting examples, on the rear surface of the window substrate 100 to improve an adhesion between the window substrate 100 and the bezel part (not illustrated) or the electrode patterns 121 and 122.

According to an embodiment, the sensor module 120 includes the base substrate 124, the electrode patterns 121 and 122 formed by stacking at least two electrode layers 121b₁, 121b₂, and 121b₃ on the base substrate 124, and groove portions 124, which are formed at edge regions of sides of the electrode patterns 121 and 122.

According to an embodiment, the base substrate 124 is made of any material, which has transparency and outputs an image of the display module 150 without being particularly limited as a material which has a predetermined strength, but is made of, for example, polyethylene terephthalate (PET), polycarbonate (PC), poly methyl methacrylate (PMMA), polyethylene naphthalate (PEN), polyethersulpon (PES), cyclic olefin polymer (COC), triacetylcellulose (TAC) film, polyvinyl alcohol (PVA) film, polyimide (PI) film, polystyrene (PS), biaxially stretched polystyrene (K resin containing biaxially oriented PS; BOPS), glass, or tempered glass. Further, one surface of the base substrate 120 is formed with the electrode patterns 121 and 122 and therefore the surface treating layer is formed by performing high frequency treatment or primer treatment, as non-limiting examples, on the one surface of the base substrate 120 to improve the adhesion between the base substrate 120 and the electrode patterns 121 and 122.

Further, according to an embodiment, the sensor module 120 includes i) the first electrode pattern 121 formed on one surface of the base substrate 124 in one direction in parallel with each other and a second electrode pattern 122 formed on the other surface of the base substrate 124 in a direction intersecting the first electrode pattern in parallel with each other (see FIG. 2A), ii) the first electrode pattern 121 formed on one surface of the first base substrate 124 in one direction in parallel with each other and a second electrode pattern 122 formed on one surface of the second base substrate 124 in a direction intersecting the first electrode pattern in parallel with each other (see FIG. 2B), iii) an electrode wiring 123, which is electrically connected to one end of the first and second electrode patterns 121 and 122, but is not limited thereto.

According to an embodiment, the first and second electrode patterns 121 and 122 generate signals using an input means of a touch to serve to allow a controller (not illustrated) to recognize touch coordinates, and in FIG. 3, the first electrode pattern 121 and the second electrode pattern 122 are illustrated in a bar pattern, but is not particularly limited thereto and a method for forming the first and second electrode patterns 121 and 122 use a dry process, a wet process, or a direct patterning process, as non-limiting examples. Here, the dry process includes sputtering or evaporation, as non-limiting examples, the wet process includes dip coating, spin coating, roll coating, or spray coating, as non-limiting examples, and the direct patterning process means screen printing, gravure printing, or inkjet printing, as non-limiting examples.

Further, as illustrated in FIG. 3, the first and second electrode patterns 121 and 122 are formed in mesh patterns, which are formed in metal wires 121a and 121b and the mesh pattern has polygonal shapes, such as a quadrangular shape, a triangular shape, and a diamond shape, but is not limited to a particular shape. Here, the first and second electrode patterns 121 and 122 are formed of the metal wires 121a and 121b, which are formed by stacking at least two electrode layers on the base substrate 124, both sides of the metal wires 121a and 121b are formed with the groove portions 124, and the groove portions 124 are filled with anticorrosive members 123, and the detailed description thereof will be described below.

According to an embodiment, adhesive layers 110 and 130 serve to bond between components of the touch sensor 10 and are made of a transparent material, for example, an optical clear adhesive (OCA), so that an image output through the display module 140 is recognized by the user without any hindrance.

According to an embodiment, the display module 140, which is bonded to one surface of the touch sensor 10 through the adhesive layers 110 and 130 and is a display device visually outputting data on a screen, is mainly a cathode ray tube (CRT), a liquid crystal display (LCD), a plasma display panel (PDP), a light emitting diode (LED), and an organic light emitting diode (OLED), but is not necessarily limited thereto.

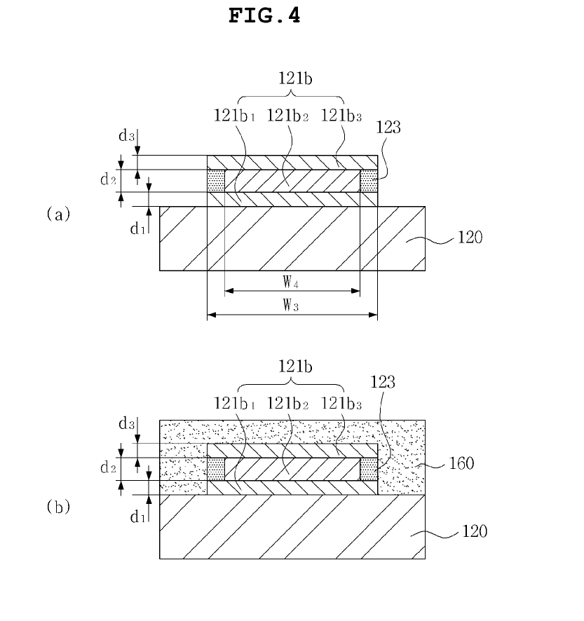

Hereinafter, a formation structure of the metal wires forming the first and second electrode patterns in the touch sensor according to the preferred embodiment of the present invention will be described in more detail with reference to FIGS. 4 to 6.

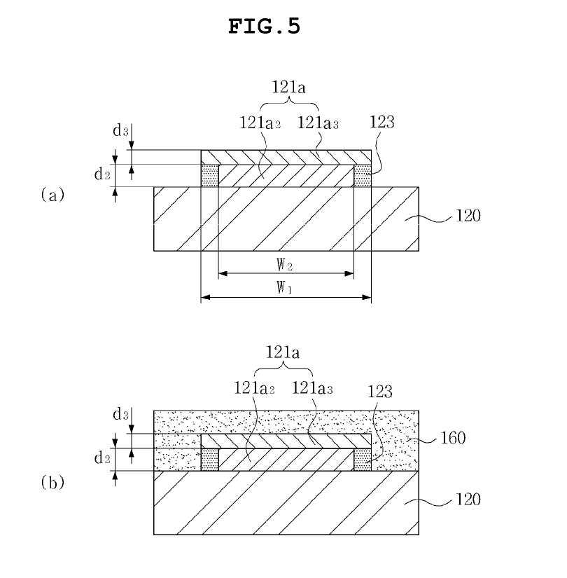

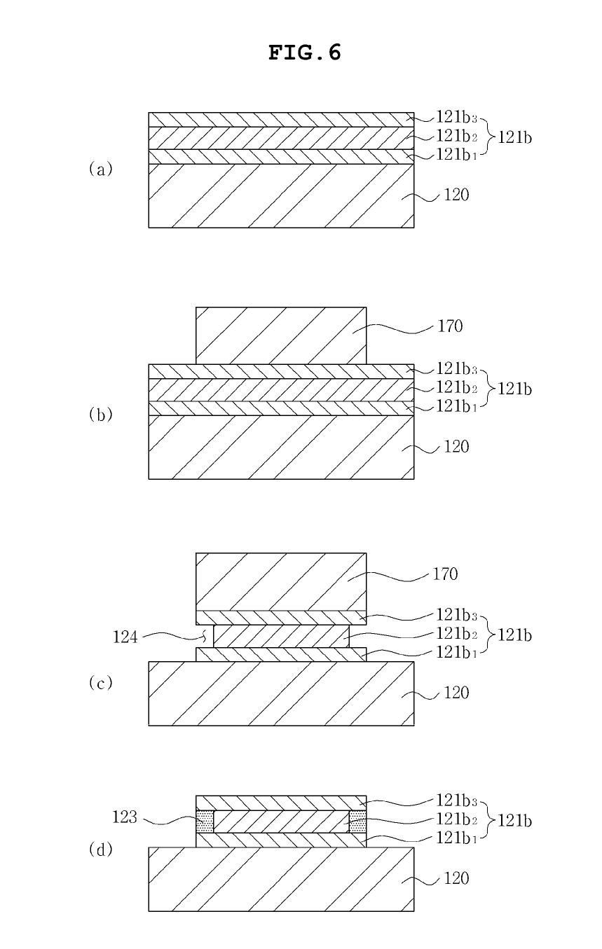

FIGS. 4A and 4B are cross-sectional views of a metal wire forming an electrode pattern according to a first embodiment of the invention taken along the line I-I′ of FIG. 3, FIGS. 5A and 5B are cross-sectionals view of a metal wire forming an electrode pattern according to a second embodiment of the invention taken along the line I-I′ of FIG. 3, and FIGS. 6A to 6D are diagrams illustrating a method for manufacturing a touch sensor according to an embodiment of the invention.

According to an embodiment, the electrode patterns 121 and 122 of the touch sensor 10 according to an embodiment of the invention are formed in the mesh patterns formed of the metal wires 121b and 121a formed by sequentially stacking a first electrode layer 121b₁, a second electrode layer 121b₂ or 121a₂, and third electrode layers 121b₃ and 121a₃ on the base substrate 124 and then patterning the first, second, and third electrode layers (see FIG. 3) and the mesh pattern has polygonal shapes such as a quadrangular shape, a triangular shape, and a diamond shape, but is not limited to a particular shape.

However, the metal wires 121b and 121a forming the electrode patterns 121 and 122 of the touch sensor 10 according to an embodiment of the invention are formed by sequentially stacking the first to third electrode layers 121b₁, 121b₂ and 121b₃, or 121a₂ and 121a₃ on the base substrate 124 and then patterning the first, second, and third electrode layers, and in the patterning process, both sides of the metal wires 121a and 121b are exposed, such that the second electrode layers 121a₂ and 121b₂ performing a signal transfer function in response to the touch input of the user to be exposed and to be corroded by moisture.

Therefore, 1) the metal wire 121b forming the electrode patterns 121 and 122 of the touch sensor 10 according to a first embodiment (FIG. 4A) of the invention is formed by sequentially stacking the first electrode layer 121b₁, the second electrode layer 121b₂, and the third electrode layer 121b₃ from one surface of the base substrate 124, in which a line width W3 of the first and third electrode layers 121b₁ and 121b₃ is formed to be larger than a line width W4 of the second electrode layer 121b₂, the groove portions 124 are formed in a region corresponding to the line width W4 of the first and third electrode layers 121b₁ and 121b₃ from both sides of the second electrode layer 121b₂, and the anticorrosive members 123 is filled in the groove portions 124. Further, the metal wire 121b further includes a damp-proofing member 160 sealing the metal wire 121b, in which the damp-proofing 160 includes, for example, imidazole and azole, as non-limiting examples (FIG. 4B).

Further, 2) the metal wire 121a forming the electrode patterns 121 and 122 of the touch sensor 10 according to a second embodiment (FIG. 5A) of the invention is formed by sequentially stacking the second electrode layer 121a₂, and the third electrode layer 121a₃ from one surface of the base substrate 124, in which a line width W1 of the third electrode layer 121a₃ is formed to be larger than a line width W2 of the second electrode layer 121a₂, the groove portions 124 are formed in a region corresponding to the line width W1 of the third electrode layer 121a₃ from both sides of the second electrode layer 121a₂, and the anticorrosive members 123 is filled in the groove portions 124. Further, the metal wire 121a further includes a damp-proofing member 160 sealing the metal wire 121b, in which the damp-proofing 160 includes imidazole and azole, as non-limiting examples (FIG. 5B).

Further, in each thickness d1, d2, and d3 of the metal wires 121a and 121b sequentially formed in a stacking direction of the first electrode layer 121b₁, the second electrode layer 121b₂ or 121a₂, and the third electrode layer 121a₃ or 121b₃ from one surface of the base substrate 124, the thicknesses d1 and d3 of the first electrode layer 121b₁ and the third electrode layer 121a₃ or 121b₃ are formed to be thinner than the thickness d2 of the second electrode layer 121b₂ or 121a₂ and the thickness d3 of the third electrode layer 121a₃ or 121b₃ are formed to be the same as the thickness d1 of the first electrode layer 121b₁.

Thus, as illustrated in FIG. 6, in the touch sensor 10 according to an embodiment of the invention, 1) after the first to third electrode layers 121b₁ and 121b₃ are sequentially stacked on the base substrate 124 (FIG. 6A), 2) a photosensitive material of a dry film (DRF), for example, is applied on the electrode layer and then the photosensitive material of a dry film, for example, of a portion in which the electrode patterns 121 and 122 are formed is removed by an exposure and development process (FIG. 6B), 3) the patterning process is performed so that the line width W1 of the first and third electrode layers 121b₁ and 121b₃ is formed to be larger than the line width W2 of the second electrode layer by using different etching rates between the first and third electrode layers 121b₁ and 121b₃ and the second electrode layer 121b₂ (FIG. 6C), 4) the anticorrosive members 123 are filled in the groove portions 124, which are formed in the region corresponding to the line width W3 of the first and third electrode layers 121b₁ and 121b₃ from both sides of the second electrode layer 121b₂ (FIG. 6D), thereby minimizing the corrosion, for example, of both sides of the second electrode layer 121b₂ due to moisture, for example.

Here, 1) the first electrode layer 121b₁ is formed at a contact surface between the base substrate 124 and the electrode patterns 121 and 122 to be able to secure an adhesion between the electrode patterns 121 and 122 and the base substrate 124, 2) the third electrode layer 121b₃ or 121a₃ is stacked at the exposed portions of the electrode patterns 121 and 122 to be able to prevent electrical reliability from reducing due to the corrosion of the electrode patterns 121 and 122, and therefore the first electrode layer 121b₁ and the third electrode layer 121b₃ or 121a₃ are made of an alloy of copper Cu and nickel Ni, in which the nickel is included to reduce visibility of copper due to the use of the electrode patterns 121 and 122 made of copper having good electrical conductivity, 3) the second electrode layer 121a₂ or 121b₂ is made of copper (Cu), aluminum (Al), or a combination thereof which is selected and applied in consideration of the electrical conductivity, but even though any metal having conductivity is used without being particularly limited, the metal needs to be selected and applied in consideration of the adhesion between the electrode layers for combination with the first electrode layer 121b₁ and the third electrode layer 121b₃ or 121a₃, the chemical characteristics due to the contact between the electrode layers, for example.

Further, the anticorrosive member 123 includes a thermosetting resin or a photocurable resin, such as organic solderability preservative and in detail, includes benzimidazole, trichlorobenzene, as non-limiting examples, which have good adhesion (wettability) to metal such as copper (Cu).

As set forth above, according to the various embodiments of the invention, it is possible to improve corrosion resistance of the upper and lower surfaces of the second electrode layer (Cu, as a non-limiting example), which transfers the signal in response to the touch input of the user, based on the structure in which the electrode pattern of the touch sensor is formed of the metal wire, which is formed by sequentially stacking the first electrode layer (alloy layer including Ni), the second electrode layer (Cu, as a non-limiting example), and the third electrode layer (alloy layer including Ni), which are made of different materials, on the base substrate, thereby securing the reliability of the signal transfer to the electrode pattern of the touch sensor.

Further, it is possible to improve the corrosion resistance of both sides of the electrode layer as well as the corrosion resistance of the upper and lower surfaces of the second electrode layer by forming the groove portions on both sides of the exposable second electrode layer and forming the anticorrosive layer by filling the groove portions with the anticorrosive member, based on the process of forming the electrode pattern formed of the metal wire using the process of sequentially stacking the first electrode layer (alloy layer including Ni), the second electrode layer (Cu, as a non-limiting example), and the third electrode layer (alloy layer including Ni), which are made of different materials, on the base substrate and then patterning the first, second, and third electrode layers.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A touch sensor, comprising:
a base substrate; and
electrode patterns formed of metal wires which are formed by stacking at least two electrode layers on the base substrate and have groove portions formed on both sides thereof,
wherein the groove portions are filled with anticorrosive members.

2. The touch sensor according to claim 1, wherein the metal wire is formed by sequentially stacking a first electrode layer, a second electrode layer, and a third electrode layer from one surface of the base substrate,
wherein a line width of the first and third electrode layers is formed to be larger than a line width of the second electrode layer,
wherein the groove portions are formed in a region corresponding to the line width of the first and third electrode layers from both sides of the second electrode layer, and
wherein the groove portions are filled with the anticorrosive members.

3. The touch sensor according to claim 1, wherein the anticorrosive member is an organic solderability preservative.

4. The touch sensor according to claim 1, wherein the metal wire is formed by sequentially stacking a second electrode layer and a third electrode layer from one surface of the base substrate,
wherein a line width of the third electrode layer is formed to be larger than a line width of the second electrode layer,
wherein the groove portions are formed in a region corresponding to a line width of the third electrode layers from both sides of the second electrode layer, and
wherein the groove portions are filled with the anticorrosive members.

5. The touch sensor according to claim 3, wherein the organic solder preservative is benzimidazole or trichlorobenzene.

6. The touch sensor according to claim 2, wherein the first and third electrode layers are made of an alloy of copper (Cu) and nickel (Ni).

7. The touch sensor according to claim 2, wherein the second electrode layer is made of copper (Cu), aluminum (Al), or a combination thereof.

8. The touch sensor according to claim 4, wherein the third electrode layer is made of an alloy of copper (Cu) and nickel (Ni).

9. The touch sensor according to claim 4, wherein the second electrode layer is made of copper (Cu), aluminum (Al), or a combination thereof.

10. The touch sensor according to claim 1, wherein the electrode pattern is formed in a mesh pattern formed of the metal wire.

11. The touch sensor according to claim 2, wherein a thickness in a stacking direction of the first and third electrode layers is formed to be thinner than that of the second electrode layer.

12. The touch sensor according to claim 4, wherein a thickness in a stacking direction of the third electrode layer is formed to be thinner than that of the second electrode layer.

13. The touch sensor according to claim 1, wherein the electrode pattern comprises:
first electrode patterns formed on one surface of the base substrate in parallel with each other, and
second electrode patterns formed on the other surface of the base substrate so as to intersect with a direction in which the first electrode patterns are formed.

14. The touch sensor according to claim 1, wherein the base substrate comprises:
first and second base substrates, and
the electrode pattern comprises:
first electrode patterns formed on one surface of a first base substrate in one direction in parallel with each other, and
second electrode patterns formed on one surface of the second base substrate in a direction intersecting the first electrode patterns in parallel with each other and formed to face the first base substrate.

15. The touch sensor according to claim 1, further comprising:
a damp-proofing member sealing the metal wire.

16. A method for manufacturing a touch sensor, comprising:
sequentially stacking at least two electrode layers on a base substrate;
forming electrode patterns formed of metal wires having groove portions formed on both sides by patterning the electrode layers; and
forming an anticorrosive layer by filling the groove portions formed on both sides of the metal wires with anticorrosive members.

17. The method according to claim 16, wherein in the stacking of the electrode layer, a first electrode layer, a second electrode layer, and a third electrode layer are sequentially stacked on the base substrate,
wherein in the forming of the electrode pattern, a line width of the first and third electrode layers forming the metal wires is formed to be larger than that of the second electrode layer and form the groove portions from both sides of the second electrode layers to a region corresponding to the line width of the first and third electrode layers, and
wherein in the forming of the anticorrosive member, the groove portions are filled with the anticorrosive members to form the anticorrosive layer.

18. The method according to claim 16, wherein the anticorrosive member is an organic solderability preservative.

19. The method according to claim 18, wherein the organic solder preservative is benzimidazole or trichlorobenzene
